(19) United States
(12) Patent Application Publication
(10) Pub. No.: US 2018/0239469 A1
(43) Pub. Date: Aug. 23, 2018

(54) Touch-Based Human-to-Computer Textile Interface

(71) Applicant: Robert A. Connor, Burnsville, MN (US)

(72) Inventor: Robert A. Connor, Burnsville, MN (US)

(73) Assignee: Medibotics LLC, St. Paul, MN (US)

(21) Appl. No.: 15/960,477

(22) Filed: Apr. 23, 2018

Related U.S. Application Data
(63) Continuation-in-part of application No. 15/227,254, filed on Aug. 3, 2016.
Application No. 15/227,254 is a continuation-in-part of application No. 14/664,832, filed on Mar. 21, 2015, now Pat. No. 9,582,072.
Application No. 14/664,832 is a continuation-in-part of application No. 14/463,741, filed on Aug. 20, 2014, now Pat. No. 9,588,582.
Application No. 15/227,254 is a continuation-in-part of application No. 15/079,447, filed on Mar. 24, 2016.
Application No. 15/079,447 is a continuation-in-part of application No. 14/463,741, filed on Aug. 20, 2014, now Pat. No. 9,588,582.
Application No. 15/079,447 is a continuation-in-part of application No. 14/664,832, filed on Mar. 21, 2015, now Pat. No. 9,582,072.
Application No. 14/664,832 is a continuation-in-part of application No. 14/463,741, filed on Aug. 20, 2014, now Pat. No. 9,588,582.
Application No. 15/227,254 is a continuation-in-part of application No. 15/130,995, filed on Apr. 17, 2016, now Pat. No. 9,891,718.
Application No. 15/227,254 is a continuation-in-part of application No. 14/736,652, filed on Jun. 11, 2015.
Application No. 14/736,652 is a continuation-in-part of application No. 14/664,832, filed on Mar. 21, 2015, now Pat. No. 9,582,072.
(60) Provisional application No. 61/878,893, filed on Sep. 17, 2013.
(60) Provisional application No. 61/976,650, filed on Apr. 8, 2014.
(60) Provisional application No. 61/878,893, filed on Sep. 17, 2013.
(60) Provisional application No. 61/878,893, filed on Sep. 17, 2013.
(60) Provisional application No. 61/976,650, filed on Apr. 8, 2014.
(60) Provisional application No. 62/150,886, filed on Apr. 22, 2015.
(60) Provisional application No. 62/150,886, filed on Apr. 22, 2015.
(60) Provisional application No. 62/014,747, filed on Jun. 20, 2014.
(60) Provisional application No. 62/100,217, filed on Jan. 6, 2015.

(51) Int. Cl. G06F 3/044

(52) U.S. Cl. CPC G06F 3/044; G06F 2203/04102

(57) ABSTRACT

This invention is a touch-based human-to-computer textile interface which is woven or otherwise integrated into an article of clothing. This interface comprises longitudinal electromagnetic energy pathways which span a portion of a person's body in a longitudinal manner, circumferential electromagnetic energy pathways which span that portion of the person's body in a partially-circumferential manner, and capacitive sensors.

### CROSS-REFERENCE TO RELATED APPLICATIONS:

This patent application is a continuation-in-part of U.S. patent application Ser. No. 15/227,254 entitled “Smart Clothing for Ambulatory Human Motion Capture” by Robert A. Connor filed on Aug. 3, 2016 which, in turn:

(1) is a continuation in part of U.S. patent application Ser. No. 14/664,832 entitled “Motion Recognition Clothing(™) with Flexible Electromagnetic, Light, or Sonic Energy Pathways” by Robert A. Connor filed on Mar. 21, 2015 which is: a continuation in part of U.S. patent application Ser. No. 14/463,741 by Robert A. Connor et al. filed on Aug. 20, 2014 which claims the priority benefit of U.S. Provisional Patent Application No. 61/878,893 by Robert A. Connor et al. filed on Sep. 17, 2013; and claims the priority benefit of U.S. Provisional Patent Application No. 61/976,650 by Robert A. Connor filed on Apr. 8, 2014;

(2) is a continuation in part of U.S. patent application Ser. No. 15/079,447 entitled “Sensor Array Spanning Multiple Radial Quadrants to Measure Body Joint Movement” by Robert A. Connor filed on Mar. 24, 2016 which in turn was: a continuation in part of U.S. patent application Ser. No. 14/463,741 by Robert A. Connor et al. filed on Aug. 20, 2014 which claims the priority benefit of U.S. Provisional Patent Application No. 61/878,893 by Robert A. Connor et al. filed on Sep. 17, 2013; a continuation in part of U.S. patent application Ser. No. 14/664,832 by Robert A. Connor filed on Mar. 21, 2015, which is a continuation in part of U.S. patent application Ser. No. 14/463,741 by Robert A. Connor et al. filed on Aug. 20, 2014 which claims the priority benefit of U.S. Provisional Patent Application No. 61/878,893 by Robert A. Connor et al. filed on Sep. 17, 2013 and claims the priority benefit of U.S. Provisional Patent Application No. 61/976,650 by Robert A. Connor filed on Apr. 8, 2014; and claims the priority benefit of U.S. Provisional Patent Application No. 62/150,886 by Robert A. Connor filed on Apr. 22, 2015;

(3) is a continuation in part of U.S. patent application Ser. No. 15/130,995 entitled “Nerd of the Rings—Devices for Measuring Finger Motion and Recognizing Hand Gestures” by Robert A. Connor filed on Apr. 17, 2016 which claims the priority benefit of U.S. Provisional Patent Application No. 62/150,886 by Robert A. Connor filed on Apr. 22, 2015; and

(4) is a continuation in part of U.S. patent application Ser. No. 14/736,652 entitled “Smart Clothing with Human-to-Computer Textile Interface” by Robert A. Connor filed on Jun. 11, 2015 which in turn was: a continuation-in-part of U.S. patent application Ser. No. 14/664,832 by Robert A. Connor filed on Mar. 21, 2015; claims the priority benefit of U.S. Provisional Patent Application No. 62/014,747 by Robert A. Connor filed on Jun. 20, 2014; and claims the priority benefit of U.S. Provisional Patent Application No. 62/100,217 filed by Robert A. Connor on Jan. 6, 2015.

The entire contents of these applications are incorporated herein by reference.

### FEDERALLY SPONSORED RESEARCH

Not Applicable

### SEQUENCE LISTING OR PROGRAM

Not Applicable

### BACKGROUND

### Field of Invention

This invention relates to smart clothing with a textile-based human-to-computer interface.

### INTRODUCTION

There are activities during which it is awkward for someone to carry and/or hold a handheld device as a touch-based human-to-computer interface. In an example, an activity may be hindered by carrying a handheld device and/or may generally require the use of at least one of a person's hands. In such situations, it would be desirable to have a touch-based human-to-computer interface which is integrated into a person's clothing such that it is readily accessible to the person for single-hand touch-based input without the person having to carry or hold a hand-held device.

### REVIEW OF THE RELEVANT ART

U.S. Pat. No. 3,711,627 (Maringulov, Jan. 16, 1973, “Device for Electrical Connection of Electric and Electronic Components and Method of Its Manufacture”) discloses a device for connecting electronic components using cloth-type interlacing. U.S. Pat. No. 6,210,771 (Post et al., Apr. 3, 2001, “Electrically Active Textiles and Articles Made Therefrom”) discloses a device with conductive fibers along one weave direction and non-conductive fibers along the opposite direction. U.S. Pat. No. 8,823,639 (Jackson et al., Sep. 2, 2014, “Elastomeric Input Device”) discloses a deformable input device for tracking three-dimensional movements. U.S. Patent Application 20050069695 (Jung et al., Mar. 31, 2005, “Keypad in Textiles with Capacitive Read-Out Circuit”) and U.S. Pat. No. 7,230,610 (Jung et al., Jun. 12, 2007, “Keypad in Textiles with Capacitive Read-Out Circuit”) disclose a keypad with at least one fabric carrier and at least one flexible electrical conductor comprising at least one weft and/or warp thread of the fabric carrier.

U.S. Patent Applications 20160048235 (Poupyrev, Feb. 18, 2016, “Interactive Textiles”), 20160048236 (Poupyrev, 2/18/2016, “Interactive Textiles within Hard Objects”), and 20170115777 (Poupyrev, 4/27/2017, “Interactive Textiles”) disclose a grid of conductive thread which is woven into an interactive textile to create a capacitive touch sensor. U.S. Patent Application 20160282988 (Poupyrev, Sep. 29, 2016, “Two-Layer Interactive Textiles”) discloses two-layer interactive textiles which form a capacitive touch sensor to detect touch input. U.S. Patent Application 20170325518 (Poupyrev et al., Nov. 16, 2017, “Interactive Fabric”) discloses interactive fabric for sensing user interactions which is integrated into a garment.

U.S. Patent Application 20150294756 (Ben Shalom et al., Oct. 15, 2015“Flexible Conducting Materials and Methods for the Manufacture Thereof”) discloses the creation of a flexible conductive material by intertwining conductive yarns or by embedding sinuous wires in flexible material. U.S. Patent Application 20090025819 (Douglas, Jan. 29, 2009, “Structure of Fabric and Electronic Components”) discloses warp and weft fibers with a combination of conducting and non-conducting fibers to which electronic components are connected. U.S. Patent Application 20120204310 (Fernandez, Aug. 16, 2012, “Reconfigurable Garment Definition and Production Method”) discloses computer-aided garment production.

U.S. Patent Application 20070202765 (Krans et al., Aug. 30, 2007, “Textile Form Touch Sensor”) discloses a textile-based touch sensor with two conductive layers and a layer of piezoresistive material between these layers. U.S. Patent Application 20100317957 (Lee et al., Dec. 16, 2010, “Three-Dimensional Wearable Electrode Set”) discloses a three-dimensional wearable electrode set. U.S. Patent Application 20140070957 (Longinotti-Buitoni et al., Mar. 13, 2014, “Wearable Communication Platform”) discloses a wearable communications garment with user-selectable inputs integrated into the garment.

U.S. Patent Application 20120323501 (Sarrafzadeh et al., Dec. 20, 2012, “Fabric-Based Pressure Sensor Arrays and Methods for Data Analysis”) discloses a fabric-based pressure sensor array with two layers of elongated conductive strips. U.S. Patent Application 20120234105 (Taylor, Sep. 20, 2012, “Elastically Stretchable Fabric Force Sensor Arrays and Methods of Making”) and U.S. Pat. No. 8,161,826 (Taylor, Apr. 24, 2012, “Elastically Stretchable Fabric Force Sensor Arrays and Methods of Making”) disclose force transducer arrays with elastically stretchable electrically conductive polymer threads configured in rows and columns.

### SUMMARY OF THE INVENTION

This invention is a touch-based human-to-computer textile interface which is woven or otherwise integrated into an article of clothing. This touch-based human-to-computer textile interface detects the touch of a human finger on its surface via longitudinal electromagnetic energy pathways which span a portion of a person's body in a longitudinal manner, circumferential electromagnetic energy pathways which span that portion of the person's body in a circumferential or partially-circumferential manner, and capacitive sensors. This invention can provide a touch-based human-to-computer interface that it is readily accessible for single-hand touch-based input by a person without their having to carry and/or hold a hand-held device.

### INTRODUCTION TO THE FIGURES

FIG. 1 shows an article of clothing with a touch-based human-to-computer textile interface which is woven or otherwise integrated into the fabric of the clothing.

FIG. 2 shows a wearable grid comprising longitudinal electromagnetic energy pathways and circumferential electromagnetic energy pathways.

### DETAILED DESCRIPTION OF THE FIGURES

In an example, this invention can be embodied in a touch-based human-to-computer textile interface. In an example, an array of electromagnetic energy sensors can comprise longitudinal energy pathways which are configured to span a portion of a person's body in a longitudinal manner and circumferential energy pathways which are configured to span that portion of the person's body in a circumferential or partially-circumferential manner. In an example, longitudinal energy pathways and circumferential energy pathways can intersect in a substantially-perpendicular manner. In an example, gaps in a grid of electromagnetic energy pathways can be shaped like squares, rhombuses, diamonds, trapezoids, or parallelograms. In an example, an electromagnetic energy sensor can be a capacitive sensor.

In an example, a touch-based human-to-computer textile interface can detect the touch of a human finger on its surface via an array of electromagnetic energy sensors. In an example, a touch-based and/or gesture-based human-to-computer textile interface can comprise an array or mesh of electromagnetic sensors which are woven or otherwise integrated into the fabric of an article of clothing to transduce human movement into computer inputs. In an example, this invention can comprise a capacitive sensor. In an example, a modular human-to-computer textile interface can be configured to flexibly conform to a portion of the circumference of a person's arm. In an example, an article of clothing can be a shirt or jacket.

In an example, this invention can be embodied in a wearable device comprising an energy-conducting grid or matrix that is configured to span the surface of a person's body. In an example, gaps in a grid or matrix can be substantially the same in size and shaped like squares, rhombuses, diamonds, trapezoids, or parallelograms. In an example, this device can comprises a plurality of energy pathways which are configured to span a portion of a person's body in a longitudinal manner; a plurality of energy pathways which are configured to span that portion of the person's body in a (partial) circumferential manner; and a plurality of energy sensors. In an example, a first energy pathway can have an axis which spans a body member in a longitudinal manner and a second energy pathway can have an axis which spans the same body member in a circular, semi-circular, or other conic sectional manner. In an example, the geometric relationship between a first energy pathway and a second energy pathway can be substantially perpendicular.

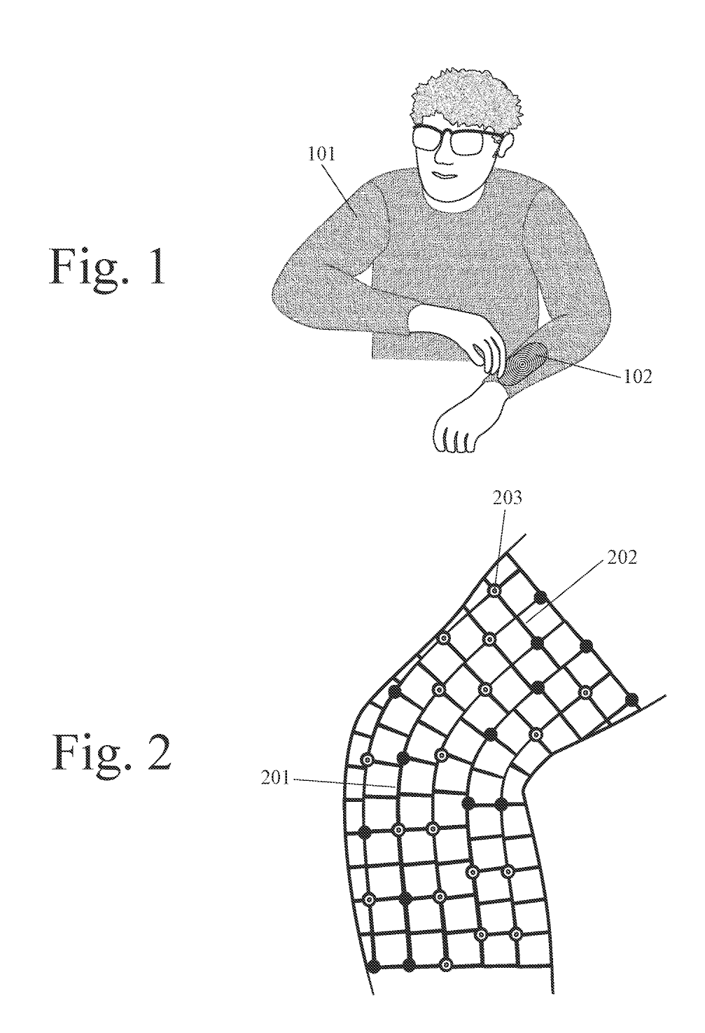

FIG. 1 shows a touch-based human-to-computer interface comprising: an article of clothing 101 worn by a person; and a touch-based human-to-computer textile interface 102, wherein the touch-based human-to-computer textile interface detects the touch of a human finger on its surface via an array of electromagnetic energy sensors, and wherein the electromagnetic energy sensors are woven or otherwise integrated into the fabric of the article of clothing.

FIG. 2 shows a wearable grid of electromagnetic energy pathways comprising: a plurality of electromagnetic energy pathways (including 201) which are configured to span a portion of a person's body in a longitudinal manner; a plurality of electromagnetic energy pathways (including 202) which are configured to span that portion of the person's body in a partially-circumferential manner; and a plurality of electromagnetic energy sensors (including 203).

I claim:

1. A touch-based human-to-computer interface comprising:
an article of clothing; and
a touch-based human-to-computer textile interface, wherein the touch-based human-to-computer textile interface detects the touch of a human finger on its surface via an array of electromagnetic energy sensors which are woven or otherwise integrated into the fabric of the article of clothing, wherein the touch-based human-to-computer textile interface further comprises longitudinal energy pathways which are configured to span a portion of the person's body in a longitudinal manner and circumferential energy pathways which are configured to span that portion of the person's body in a circumferential or partially-circumferential manner, and wherein the electromagnetic energy sensors are capacitive sensors.

2. A touch-based human-to-computer textile interface comprising:
an article of clothing;
longitudinal energy pathways woven or otherwise integrated into the fabric of the article of clothing which are configured to span a portion of the person's body in a longitudinal manner;
circumferential energy pathways woven or otherwise integrated into the fabric of the article of clothing which are configured to span that portion of the person's body in a circumferential or partially-circumferential manner; and
capacitive sensors.
